(19) United States
(12) Patent Application Publication
(10) Pub. No.: US 2013/0144967 A1
(43) Pub. Date: Jun. 6, 2013

(54) Scalable Queuing System

(71) Applicants: Han Chen, White Plains, NY (US); Minkyong Kim, Scarsdale, NY (US); Hui Lei, Scarsdale, NY (US); Zhe Zhang, Elmsford, NY (US)

(72) Inventors: Han Chen, White Plains, NY (US); Minkyong Kim, Scarsdale, NY (US); Hui Lei, Scarsdale, NY (US); Zhe Zhang, Elmsford, NY (US)

(73) Assignee: INTERNATIONAL BUSINESS MACHINES CORPORATION, Armonk, NY (US)

(21) Appl. No.: 13/311,068

(22) Filed: Dec. 5, 2011

(51) Int. Cl. G06F 15/167

(52) U.S. Cl. 709/213

(57) ABSTRACT

A method, an apparatus and an article of manufacture for providing queuing semantics in a distributed queuing service while maintaining service scalability. The method includes supporting at least one of an en-queue and a de-queue operation of one or more queued messages in a non-guaranteed order, maintaining the ordering of the one or more queued messages, and routing an en-queue operation to a persistent queue server and a de-queue operation to a cache manager in the maintained ordering of the one or more queued messages to provide queuing semantics in a distributed queuing service while maintaining service scalability.

### FIELD OF THE INVENTION

Embodiments of the invention generally relate to information technology, and, more particularly, to message queuing services.

### BACKGROUND OF THE INVENTION

Challenges exist in providing first in, first out (FIFO) message delivery without compromising service performance and scalability. Without a FIFO guarantee, a queuing has effectively degraded to a storage service. It is also a challenging problem because providing FIFO semantics in a distributed queuing service is at odds with maintaining service scalability. Distributed queuing entails queue partitioning and replication. FIFO semantics require some form of locking or serialization, which is inherently unscalable.

Existing approaches for queuing services include enterprise queuing products, which have consistency but suffer from reduced scalability, and cloud-based queuing services, which have scalability but reduced consistency. Accordingly, a need exists for providing enhanced queuing semantics in a distributed queuing service while maintaining service scalability.

### SUMMARY OF THE INVENTION

In one aspect of the present invention, techniques for providing a scalable queuing system are provided. An exemplary computer-implemented method for providing queuing semantics in a distributed queuing service while maintaining service scalability can include steps of supporting at least one of an en-queue and a de-queue operation of one or more queued messages in a non-guaranteed order, maintaining the ordering of the one or more queued messages, and routing an en-queue operation to a persistent queue server and a de-queue operation to a cache manager in the maintained ordering of the one or more queued messages to provide queuing semantics in a distributed queuing service while maintaining service scalability.

Another aspect of the invention or elements thereof can be implemented in the form of an article of manufacture tangibly embodying computer readable instructions which, when implemented, cause a computer to carry out a plurality of method steps, as described herein. Furthermore, another aspect of the invention or elements thereof can be implemented in the form of an apparatus including a memory and at least one processor that is coupled to the memory and operative to perform noted method steps.

Yet further, another aspect of the invention or elements thereof can be implemented in the form of means for carrying out the method steps described herein, or elements thereof; the means can include (i) hardware module(s), (ii) software module(s), or (iii) a combination of hardware and software modules; any of (i)-(iii) implement the specific techniques set forth herein, and the software modules are stored in a tangible computer-readable storage medium (or multiple such media).

These and other objects, features and advantages of the present invention will become apparent from the following detailed description of illustrative embodiments thereof, which is to be read in connection with the accompanying drawings.

### BRIEF DESCRIPTION OF THE DRAWINGS

FIG. 1 is a diagram illustrating system architecture, according to an embodiment of the present invention;

FIG. 2 is a flow diagram illustrating techniques for providing queuing semantics in a distributed queuing service while maintaining service scalability, according to an embodiment of the invention; and

FIG. 3 is a system diagram of an exemplary computer system on which at least one embodiment of the invention can be implemented.

### DETAILED DESCRIPTION OF EMBODIMENTS

As described herein, an aspect of the present invention includes providing a scalable queuing system with strong consistency. The techniques detailed herein include providing enhanced queuing semantics (in particular, FIFO message delivery) in a distributed queuing service while maintaining service scalability.

An example embodiment of the invention includes using a caching layer to stage data for de-queue operations. Cached messages are organized in FIFO order per queue. Also, only de-queue operations will hit the cache, and en-queue operations will access the queue storage directly.

Additionally, in an example embodiment of the invention, pre-fetch and order queued messages are continuously in background for the caches. Because en-queue and de-queue are asynchronous operations, there is little impact on the performance and scalability of both en-queue and de-queue operations. For applications that do not need FIFO, caching can be skipped. Further, de-queue operations will access the queue storage directly.

As detailed herein, a persistent queue layer (such as, for example, the current IBM WebSphere MQ cluster) supports regular en-queue and de-queue operations without trying to guarantee FIFO order. In an aspect of the invention, a reordering layer provides a collection of cache managers which maintain the FIFO ordering of queued messages. Each cache manager maintains caches for a set of queues, and each cache corresponds to a single queue and keeps the oldest messages (that is, the messages to be served next) from that queue in a FIFO order. Additionally, pre-fetchers in the background can periodically pre-fetch the next batch of queued messages, sort them and insert them into the caches. An aspect of the invention also includes a service dispatcher routing an en-queue operation to a persistent queue server, and routing a de-queue operation to a cache manager.

Further, according to an aspect of the invention, applications that do not require FIFO can read from the persistent layer directly. An embodiment of the invention can also include relaxing consistency from total FIFO to local, per-producer FIFO. It may be sufficient to maintain FIFO for messages from the same producer only. If so, a queue can be distributed across multiple cache managers as long as messages from the same producer are maintained by the same cache manager.

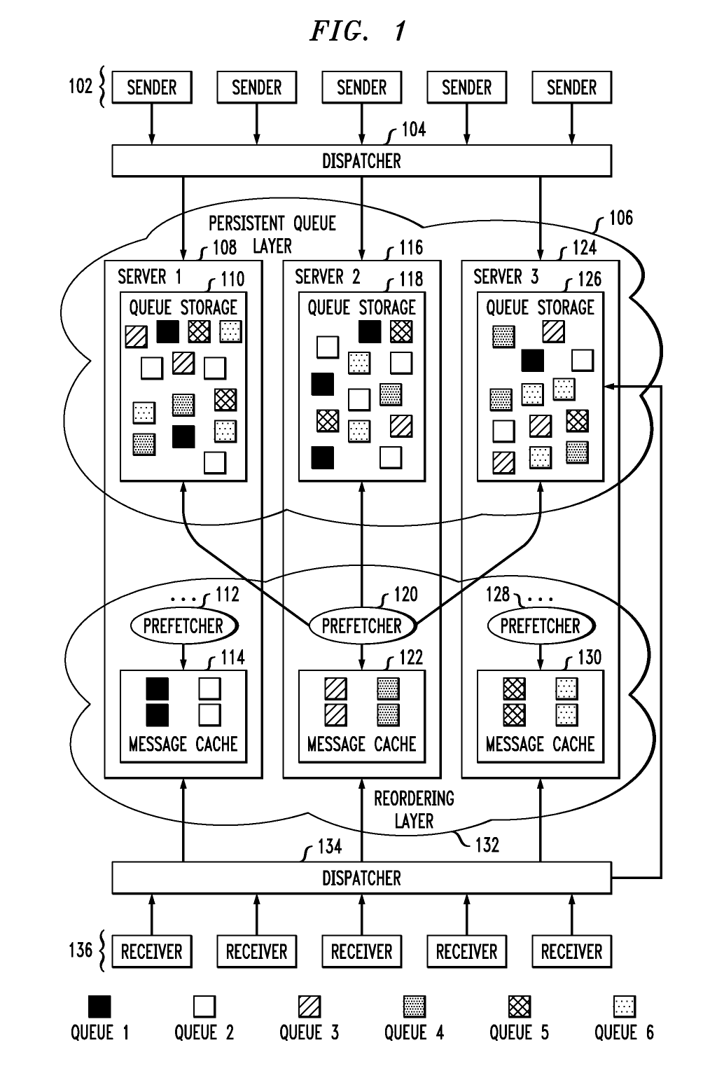

FIG. 1 is a diagram illustrating system architecture, according to an embodiment of the present invention. By way of illustration, FIG. 1 depicts sender components 102, a dispatcher module 104, as well as receiver components 136 and a dispatcher module 134. Additionally, FIG. 1 depicts a persistent queue layer 106 and a reordering layer 132, which encompass server(1) 108 (which includes a queue storage 110, a prefetcher module 112 and a message cache 114), server(2) 116 (which includes a queue storage 118, a prefetcher module 120 and a message cache 122) and server(3) 124 which includes a queue storage 126, a prefetcher module 128 and a message cache 130).

The sender components 102 generate data messages. Each sender component connects to the dispatcher module 104 when there is a message to send. Dispatcher module 104 will select a server (108, 116 or 124) from the persistent queue layer 106. The sender component will send the message to the selected server. The selected server will store the message in a respective queue storage component (110, 118 or 126). The respective prefetcher module (112, 118 or 128) on every server is a continuously running program, and it will periodically for example, every five seconds) connect to the queue storage component of all servers (110, 118 and 126) to collect the oldest messages on that server. The oldest messages are sorted and stored in the message caches (114, 122 and 130). For de-queue operations, each queue is mapped to a fixed cache manager. The dispatcher component 134 is aware of this mapping information for all queues. When a receiver component 136 needs to receive a message, it connects to the dispatcher component 134. Dispatcher component 134 then directs the request to the correct message cache (114, 122 or 130).

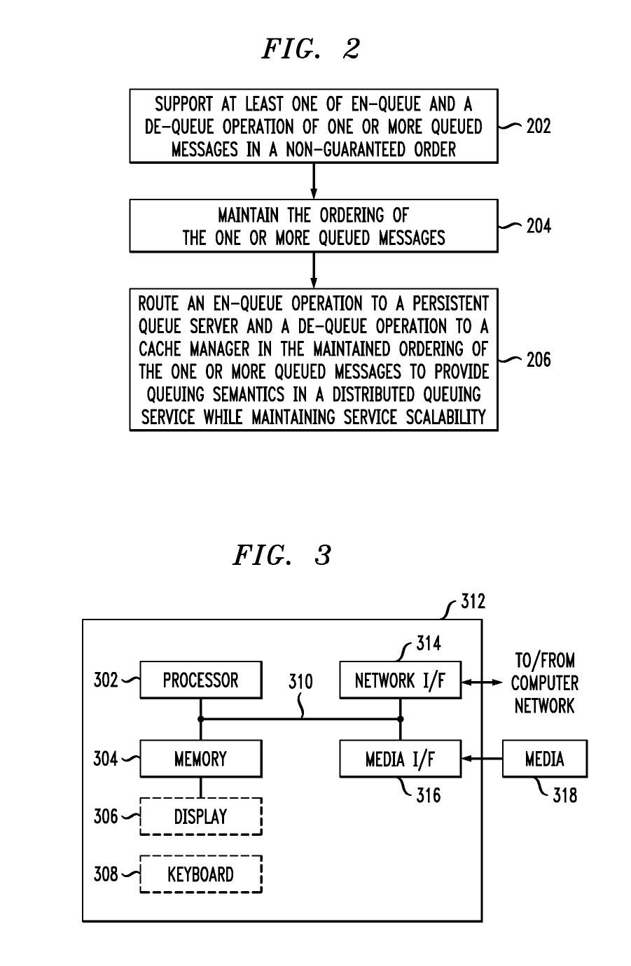

FIG. 2 is a flow diagram illustrating techniques for providing queuing semantics in a distributed queuing service while maintaining service scalability, according to an embodiment of the present invention. As detailed herein, the queuing semantics can include first in, first out (FIFO) message delivery. Step 202 includes supporting at least one of an en-queue and a de-queue operation of one or more queued messages in a non-guaranteed order. This step can be carried out, for example, using a persistent queue layer. As described herein, supporting the operation(s) indicates providing the necessary functionality.

Step 204 includes maintaining the ordering of the one or more queued messages. This step can be carried out, for example, using at least one cache manager within a reordering layer. Maintaining the ordering of the queued messages includes maintaining at least one cache for a set of at least one queue via a cache manager. Additionally, each cache corresponds to a single queue, and each cache keeps a message to be served next from the single queue in a FIFO order.

An aspect of the invention can further include periodically pre-fetching a next batch of queued messages, sorting the next batch of queued messages, and inserting the next batch of queued messages into at least one cache (via a pre-fetcher in the background).

Step 206 includes routing an en-queue operation to a persistent queue server and a de-queue operation to a cache manager in the maintained ordering of the one or more queued messages to provide queuing semantics in a distributed queuing service while maintaining service scalability. This step can be carried out, for example, using a service dispatcher. As detailed herein, an aspect of the invention includes using a cluster of distributed servers. Previously, in existing approaches, in order to provide queuing semantics, a queuing system had to be based on a single server. A single server lacks scalability (because when workload increases the single server will not be able to handle it with good performance). A cluster of distributed servers provides scalability.

The techniques depicted in FIG. 2 can also include staging data for de-queue operations via a caching layer, as well as organizing two or more cached messages in FIFO order per queue. An example embodiment of the invention additionally includes skipping caching for an application that does not need FIFO, enabling a de-queue operation to access a queue storage directly, and enabling an application that does not require FIFO to read directly from a persistent layer.

Further, the techniques depicted in FIG. 2 can include relaxing consistency from total FIFO to local, per-producer FIFO. This step is accomplished by relaxing the queue-to-cache mapping. Without this relaxation, each queue can be mapped to only one message cache. With this relaxation, each queue can be mapped to multiple message caches. The only remaining restriction is that all messages that are in the same queue and belonging to the same sender are mapped to a fixed message cache. The techniques depicted in FIG. 2 can also, as described herein, include providing a system, wherein the system includes distinct software modules, each of the distinct software modules being embodied on a tangible computer-readable recordable storage medium. All the modules (or any subset thereof) can be on the same medium, or each can be on a different medium, for example. The modules can include any or all of the components shown in the figures. In an aspect of the invention, the modules include a persistent queue layer, a reordering layer and a service dispatcher that can run, for example on a hardware processor. The method steps can then be carried out using the distinct software modules of the system, as described above, executing on a hardware processor. Further, a computer program product can include a tangible computer-readable recordable storage medium with code adapted to be executed to carry out at least one method step described herein, including the provision of the system with the distinct software modules.

Additionally, the techniques depicted in FIG. 2 can be implemented via a computer program product that can include computer useable program code that is stored in a computer readable storage medium in a data processing system, and wherein the computer useable program code was downloaded over a network from a remote data processing system. The program can be installed without a network download. Also, in an aspect of the invention, the computer program product can include computer useable program code that is stored in a computer readable storage medium in a server data processing system, and wherein the computer useable program code are downloaded over a network to a remote data processing system for use in a computer readable storage medium with the remote system.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in a computer readable medium having computer readable program code embodied thereon.

An aspect of the invention or elements thereof can be implemented in the form of an apparatus including a memory and at least one processor that is coupled to the memory and operative to perform exemplary method steps.

Additionally, an aspect of the present invention can make use of software running on a general purpose computer or workstation. With reference to FIG. 3, such an implementation might employ, for example, a processor 302, a memory 304, and an input/output interface formed, for example, by a display 306 and a keyboard 308. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory), ROM (read only memory), a fixed memory device (for example, hard drive), a removable memory device (for example, diskette), a flash memory and the like. In addition, the phrase “input/output interface” as used herein, is intended to include, for example, a mechanism for inputting data to the processing unit (for example, mouse), and a mechanism for providing results associated with the processing unit (for example, printer). The processor 302, memory 304, and input/output interface such as display 306 and keyboard 308 can be interconnected, for example, via bus 310 as part of a data processing unit 312. Suitable interconnections, for example via bus 310, can also be provided to a network interface 314, such as a network card, which can be provided to interface with a computer network, and to a media interface 316, such as a diskette or CD-ROM drive, which can be provided to interface with media 318.

Accordingly, computer software including instructions or code for performing the methodologies of the invention, as described herein, may be stored in an associated memory devices (for example, ROM, fixed or removable memory) and, when ready to be utilized, loaded in part or in whole (for example, into RAM) and implemented by a CPU. Such software could include, but is not limited to, firmware, resident software, microcode, and the like.

A data processing system suitable for storing and/or executing program code will include at least one processor 302 coupled directly or indirectly to memory elements 304 through a system bus 310. The memory elements can include local memory employed during actual implementation of the program code, bulk storage, and cache memories which provide temporary storage of at least some program code in order to reduce the number of times code must be retrieved from bulk storage during implementation.

Input/output or I/O devices (including but not limited to keyboards 308, displays 306, pointing devices, and the like) can be coupled to the system either directly (such as via bus 310) or through intervening I/O controllers (omitted for clarity).

Network adapters such as network interface 314 may also be coupled to the system to enable the data processing system to become coupled to other data processing systems or remote printers or storage devices through intervening private or public networks. Modems, cable modem and Ethernet cards are just a few of the currently available types of network adapters.

As used herein, including the claims, a “server” includes a physical data processing system (for example, system 312 as shown in FIG. 3) running a server program. It will be understood that such a physical server may or may not include a display and keyboard.

As noted, aspects of the present invention may take the form of a computer program product embodied in a computer readable medium having computer readable program code embodied thereon. Also, any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using an appropriate medium, including but not limited to wireless, wireline, optical fiber cable, RF, etc., or any suitable combination of the foregoing.

Computer program code for carrying out operations for aspects of the present invention may be written in any combination of at least one programming language, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. Accordingly, an aspect of the invention includes an article of manufacture tangibly embodying computer readable instructions which, when implemented, cause a computer to carry out a plurality of method steps as described herein.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, component, segment, or portion of code, which comprises at least one executable instruction for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It should be noted that any of the methods described herein can include an additional step of providing a system comprising distinct software modules embodied on a computer readable storage medium; the modules can include, for example, any or all of the components shown in FIG. 1. The method steps can then be carried out using the distinct software modules and/or sub-modules of the system, as described above, executing on a hardware processor 302. Further, a computer program product can include a computer-readable storage medium with code adapted to be implemented to carry out at least one method step described herein, including the provision of the system with the distinct software modules.

In any case, it should be understood that the components illustrated herein may be implemented in various forms of hardware, software, or combinations thereof; for example, application specific integrated circuit(s) (ASICS), functional circuitry, an appropriately programmed general purpose digital computer with associated memory, and the like. Given the teachings of the invention provided herein, one of ordinary skill in the related art will be able to contemplate other implementations of the components of the invention.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of another feature, integer, step, operation, element, component, and/or group thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

At least one aspect of the present invention may provide a beneficial effect such as, for example, providing enhanced queuing semantics in a distributed queuing service while maintaining service scalability.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for providing queuing semantics in a distributed queuing service while maintaining service scalability, wherein the method comprises:
supporting at least one of an en-queue and a de-queue operation of one or more queued messages in a non-guaranteed order;
maintaining the ordering of the one or more queued messages; and
routing an en-queue operation to a persistent queue server and a de-queue operation to a cache manager in the maintained ordering of the one or more queued messages to provide queuing semantics in a distributed queuing service while maintaining service scalability;
wherein at least one of the steps is carried out by a computer device.

2. The method of claim 1, wherein the queuing semantics comprise first in, first out (FIFO) message delivery.

3. The method of claim 1, wherein maintaining the ordering of the one or more queued messages comprises maintaining at least one cache for a set of at least one queue via a cache manager.

4. The method of claim 3, wherein each cache corresponds to a single queue.

5. The method of claim 3, wherein each cache keeps a message to be served next from the single queue in a FIFO order.

6. The method of claim 3, further comprising:
periodically pre-fetching a next batch of queued messages;
sorting the next batch of queued messages; and
inserting the next batch of queued messages into at least one cache.

7. The method of claim 1, further comprising:
staging data for de-queue operations via a caching layer.

8. The method of claim 7, further comprising:
organizing two or more cached messages in FIFO order per queue.

9. The method of claim 1, further comprising:
skipping caching for an application that does not need FIFO.

10. The method of claim 1, further comprising:
enabling a de-queue operation to access a queue storage directly.

11. The method of claim 1, further comprising:
enabling an application that does not require FIFO to read directly from a persistent layer.

12. The method of claim 1, further comprising:
relaxing consistency from total FIFO to local, per-producer FIFO.

13. The method of claim 1, further comprising:
providing a system, wherein the system comprises at least one distinct software module, each distinct software module being embodied on a tangible computer-readable recordable storage medium, and wherein the at least one distinct software module comprises a persistent queue layer, a reordering layer and a service dispatcher executing on a hardware processor.

14. An article of manufacture comprising a computer readable storage medium having computer readable instructions tangibly embodied thereon which, when implemented, cause a computer to carry out a plurality of method steps comprising:
supporting at least one of an en-queue and a de-queue operation of one or more queued messages in a non-guaranteed order;
maintaining the ordering of the one or more queued messages; and
routing an en-queue operation to a persistent queue server and a de-queue operation to a cache manager in the maintained ordering of the one or more queued messages to provide queuing semantics in a distributed queuing service while maintaining service scalability.

15. The article of manufacture of claim 14, wherein the queuing semantics comprise first in, first out (FIFO) message delivery.

16. The article of manufacture of claim 14, wherein maintaining the ordering of the one or more queued messages comprises maintaining at least one cache for a set of at least one queue via a cache manager.

17. The article of manufacture of claim 16, wherein the computer readable instructions which, when implemented, further cause a computer to carry out a method step comprising:
periodically pre-fetching a next batch of queued messages;
sorting the next batch of queued messages; and
inserting the next batch of queued messages into at least one cache.

18. The article of manufacture of claim 14, wherein the computer readable instructions which, when implemented, further cause a computer to carry out a method step comprising:
staging data for de-queue operations via a caching layer.

19. The article of manufacture of claim 14, wherein the computer readable instructions which, when implemented, further cause a computer to carry out a method step comprising:
relaxing consistency from total FIFO to local, per-producer FIFO.

20. A system for providing queuing semantics in a distributed queuing service while maintaining service scalability, comprising:
at least one distinct software module, each distinct software module being embodied on a tangible computer-readable medium;
a memory; and
at least one processor coupled to the memory and operative for:
supporting at least one of an en-queue and a de-queue operation of one or more queued messages in a non-guaranteed order;
maintaining the ordering of the one or more queued messages; and
routing an en-queue operation to a persistent queue server and a de-queue operation to a cache manager in the maintained ordering of the one or more queued messages to provide queuing semantics in a distributed queuing service while maintaining service scalability.

21. The system of claim 20, wherein the queuing semantics comprise first in, first out (FIFO) message delivery.

22. The system of claim 20, wherein the at least one processor coupled to the memory operative for maintaining the ordering of the one or more queued messages is further operative for maintaining at least one cache for a set of at least one queue via a cache manager.

23. The system of claim 22, wherein the at least one processor coupled to the memory is further operative for:
periodically pre-fetching a next batch of queued messages;
sorting the next batch of queued messages; and
inserting the next batch of queued messages into at least one cache.

24. The system of claim 20, wherein the at least one processor coupled to the memory is further operative for:
staging data for de-queue operations via a caching layer.

25. The system of claim 20, wherein the at least one processor coupled to the memory is further operative for:
relaxing consistency from total FIFO to local, per-producer FIFO.
